(19) United States
(12) Patent Application Publication
(10) Pub. No.: US 2016/0292613 A1
(43) Pub. Date: Oct. 6, 2016

(54) Skill Identification System

(71) Applicant: ADP, LLC, Roseland, NJ (US)

(72) Inventors: Agatha Kurjanowicz, New York, NY (US); Dominic Gadoury, New York, NY (US)

(21) Appl. No.: 14/679,231

(22) Filed: Apr. 6, 2015

(51) Int. Cl. G06Q 10/06; G06F 17/30

(52) U.S. Cl. CPC G06Q 10/06398; G06F 17/30876; G06F 17/30598

(57) ABSTRACT

A computer system searches a network for information about a person. The computer system also identifies a skill for the person from the information found in the network. Further, the computer system identifies evidence of the skill that meets a policy that identifies when the skill is valid. Still further, the computer system adds the skill to a group of skills for the person in a database of skills for people in the organization when the skill is valid, enabling performing an operation for the organization based on the skills for the people in the organization for which the evidence is present that meets the policy.

### BACKGROUND INFORMATION

1. Field

The present disclosure relates generally to an improved computer system and, in particular, to a method and apparatus for accessing information in a computer system. Still more particularly, the present disclosure relates to a method and apparatus for accessing information about people in a computer system.

2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance, wellness plans, and other programs and organizations using an employee information system. As yet another example, an information system may be used to determine when to hire new employees, assign employees to projects, perform reviews for employees, and other suitable operations for the organization. As another example, a research department in the organization may use an information system to store and analyze information to research new products, perform reviews of employees, hire new employees, analyze products, or for other suitable operations.

Currently used information systems include databases. These databases store information about the organization. For example, these databases store information about employees, products, research, product analysis, business plans, and other information about the organization.

The information systems may be used in performing operations for an organization. The operations may include hiring operations and project assignments.

For example, in filling a position in an organization, requirements for the position are identified as part of the process. The position may be filled from within the organization or by hiring someone from outside of the organization.

As another example, in assigning people to projects, various characteristics about the people may be used to identify who is most suited for different projects. The characteristics may include, for example, skills and experience that may be considered to identify people with the skills needed for a project.

A search in one or more databases in one or more information systems may be made to identify information about characteristics for people who may be suitable for a particular project. The search may return performance reviews, prior project assignments, emails, publications, tenure at the organization, and other information about people in the organization that may be used to identify who may be assigned to a project.

In filling a position, skills that are desired for the position may be identified from searching one or more information systems. Searching one or more information systems may identify information about characteristics that may be desirable for the position. For example, information about skills for people in the same or similar positions may be reviewed.

Information about the employees may be searched and viewed to perform various operations within an organization. Searching information systems may return large amounts of information that are reviewed when performing operations such as compensation changes and project assignments. The results of a database search may be more cumbersome and time-consuming than desired.

Therefore, it would be desirable to have a method and apparatus that take into account at least some of the issues discussed above, as well as other possible issues. For example, it would be desirable to have a method and apparatus that overcome a technical problem of having amounts of information that make identifying skills for people more cumbersome and time-consuming than desired.

### SUMMARY

An embodiment of the present disclosure provides a method for identifying skills in an organization. A computer system searches a network for information about a person. The computer system also identifies a skill for the person from the information found in the network. Further, the computer system identifies evidence of the skill that meets a policy that identifies when the skill is valid. Still further, the computer system adds the skill to a group of skills for the person in a database of skills for people in the organization when the skill is valid, enabling performing an operation for the organization based on the skills for the people in the organization for which the evidence is present that meets the policy.

Another embodiment of the present disclosure provides a computer system comprising a display system and a skill identifier in communication with the display system. The skill identifier searches a network for information about a person; identifies a skill for the person from the information found in the network. Further, the skill identifier identifies evidence of the skill that meets a policy identifying when the skill is a valid. Still further, the skill identifier adds the skill to a group of skills for the person in a database of skills for people in an organization when the skill is valid, enabling performing an operation for the organization based on skills for the people in the organization for which the evidence is present that meets the policy.

Yet another embodiment of the present disclosure provides computer program product for identifying skills in an organization comprising a computer readable storage media, and first program code, second program code, third program code, and fourth program code stored on the computer readable storage media. The first program code searches a network for information about a person. The second program code identifies a skill for the person from the information found in the network. The third program code identifies evidence of the skill that meets a policy that identifies when the skill is valid. The fourth program code adds the skill to a group of skills for the person in a database of skills for people in the organization when the skill is valid, enabling performing an operation for the organization based on the skills for the people in the organization for which the evidence is present that meets the policy.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is an illustration of a block diagram of data flow for identifying skills in an organization in accordance with an illustrative embodiment;

FIG. 3 is an illustration of a block diagram of data flow for identifying skills in an organization in accordance with an illustrative embodiment;

FIG. 4 is an illustration of a block diagram of a tag in accordance with an illustrative embodiment;

FIG. 5 is an illustration of a block diagram of an endorsement of skills for a person in accordance with an illustrative embodiment;

FIG. 6 is an illustration of a graphical user interface for viewing endorsements of skills for a person in accordance with an illustrative embodiment;

FIG. 7 is an illustration of a graphical user interface for adding a skill to a group skills for a person in accordance with an illustrative embodiment;

FIG. 8 is an illustration of a graphical user interface for adding an endorsement to a skill for a person in accordance with an illustrative embodiment;

FIG. 9 is an illustration of a graphical user interface for displaying statistics about skills for people of an organization in accordance with an illustrative embodiment;

FIG. 10 is an illustration of a flowchart of a process for identifying skills in accordance with an illustrative embodiment;

FIG. 11 is an illustration of a flowchart of a process for identifying skills in accordance with an illustrative embodiment;

FIG. 12 is an illustration of a flowchart of a process for identifying statistics about skills in accordance with an illustrative embodiment; and

FIG. 13 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about an employee when performing certain operations. The illustrative embodiments also recognize and take into account that searching information systems may be more cumbersome and time-consuming than desirable.

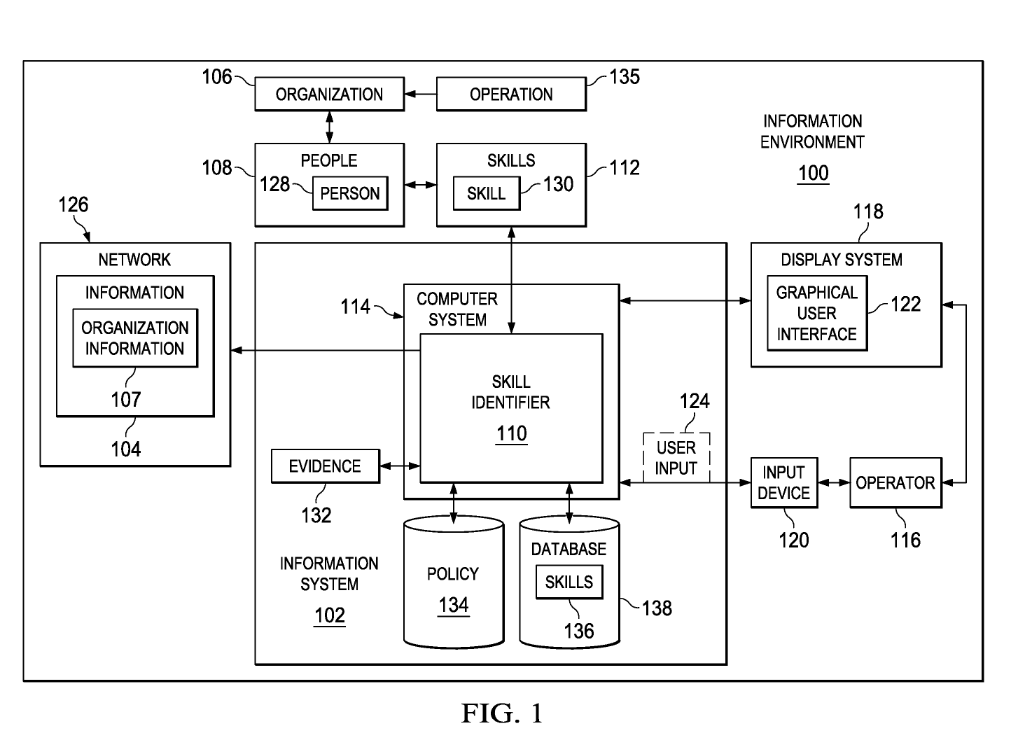

With reference now to the figures and, in particular, reference to FIG. 1, an illustration of a block diagram of an information environment is depicted in accordance with an illustrative embodiment. In this illustrative example, information environment 100 includes information system 102. Information system 102 provides access to information 104. The portion of information 104 that is specifically for organization 106 is organization information 107. The access of information 104 may be at least one of reading, writing, modifying, storing, or deleting information 104.

Information 104 may be information for at least one of people, products, services, business plans, performance reviews, payroll, human resources, benefits administration, business plans, marketing, research, product development, or other suitable information. As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, organization 106 may be, for example, a corporation, a partnership, a charitable organization, a city, a government agency, or some other suitable type of organization. People 108 may be employees of organization 106. In other illustrative examples, people 108 may be members of organization 106 without being employees.

Information system 102 provides access to information 104. For example, information system 102 may be used for at least one of payroll, benefits administration, product development, marketing, or other suitable purposes in organization 106.

In one illustrative example, skill identifier 110 may be used to perform at least one of identifying skills 112 or analyzing skills 112 for people 108. As depicted, skill identifier 110 may be implemented in software, hardware, firmware or a combination thereof. When software is used, the operations performed by skill identifier 110 may be implemented in program code configured to run on hardware, such as a processor unit. When firmware is used, the operations performed by skill identifier 110 may be implemented in program code and data and stored in persistent memory to run on a processor unit. When hardware is employed, the hardware may include circuits that operate to perform the operations in skill identifier 110.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

As depicted, skill identifier 110 may be implemented in computer system 114. Computer system 114 is a hardware system that includes one or more data processing systems. When more than one data processing system is present, those data processing systems may be in communication with each other using a communications medium. The communications medium may be a network. The data processing systems may be selected from at least one of a computer, a server computer, a tablet, or some other suitable data processing system.

In the illustrative example, operator 116 may interact with skill identifier 110 in computer system 114 to access information 104 about people 108. For example, operator 110 may interact with skill identifier 110 in information system 102 to identify skills 112 and analyze skills 112 for people 108.

As depicted, operator 116 may interact with skill identifier 110 using display system 118 and input device 120. Graphical user interface 122 is displayed on display system 118 and provides visualization of information 104 and interaction with skill identifier 110.

As depicted, display system 118 is a hardware system and includes one or more display devices on which graphical user interface 122 may be displayed. The display devices may include at least one of a light emitting diode display (LED), a liquid crystal display (LCD), an organic light emitting diode display (OLED), or some other suitable device on which graphical user interface 122 can be displayed. Operator 116 may interact with graphical user interface 122 through user input 124 generated by input device 120. Input device 120 may be, for example, a mouse, a keyboard, a trackball, a touchscreen, a stylus, or some other suitable type of input device.

In operation, skill identifier 110 in computer system 114 provides a method for identifying skills 112 in organization 106. Skill identifier 110 searches network 126 for information 104 about person 128 in people 108. Network 126 is located in at least one of information system 102 or outside of information system 102. For example, network 126 may include at least one of a local area network (LAN), a wide area network (WAN), the Internet, an intranet, or some other suitable type of network.

Skill identifier 110 identifies skill 130 for person 128 from information 104 found in network 126. Additionally, skill identifier 110 identifies evidence 132 of skill 130 that meets policy 134 when skill 130 is valid. When skill 130 is valid, skill 130 may be relied upon to perform operation 135 for organization 106 in this illustrative example.

As depicted, the identification of evidence 132 may be made by searching network 126. In searching network 126, a search of information 104 may be performed for evidence 132. In other illustrative examples, evidence 132 may be identified in other ways. For example, evidence 132 may be found in other locations or in other manners other than searching network 126. In this example, if skill 130 was identified through an endorsement found in information 104, a request may be made to the endorser for verification. Additionally, the potentials of the endorser also may be examined to determine whether the endorser is considered credible based on policy 134.

In this illustrative example, policy 134 is a group of rules. Policy 134 also may include data used to apply the group of rules. As used herein, the “group of,” when used with reference to items, means one or more items. For example, a “group of rules” is one or more rules.

As depicted, skill identifier 110 adds skill 130 to a group of skills 136 for person 128 in database 138 of skills 112 for people 108 in organization 106 when skill 130 is valid. Skill 130 is considered to be a skill that can be added to a group of skills 136 when evidence 132 of skill 130 meets policy 134.

As a result, more certainty is present in performing operation 135 based on an identification of skills 112 for people 108 using skill identifier 110. In other words, an endorsement of person 128 having skill 130 may not result in skill 130 being added to the group of skills 136 for person 128. If evidence 132 of skill 130 does not meet one or more rules in policy 134. In this manner, performing operation 135 for organization 106 is enabled based on skills 112 for people 108 in organization 106.

The illustrative example in FIG. 1 and the examples in the other subsequent figures provide one or more technical solutions to overcome a technical problem of having amounts of information that make identifying characteristics of people more cumbersome and time-consuming than desired. For example, skill identifier 110 identifies and adds skill 130 to a group of skills 136 for person 128 when skill 130 is valid. As another example, skill identifier 110 identifies skill 130 as being valid when evidence 132 of skill 130 meets policy 134 indicating when skills are valid.

In this manner, the use of skill identifier 110 has a technical effect of reducing time, effort, or both in identifying skills 112 for people 108. In this manner, operations performed for organization 106 may be performed more efficiently as compared to currently used systems for identifying skills 112 for people 108. For example, skills 112 may be used in operations selected from at least one of hiring, benefits administration, payroll, performance reviews, forming teams for new products, assigning research projects, or other suitable operations for organization 106.

As a result, computer system 114 operates as a special purpose computer system in which skill identifier 110 in computer system 114 enables identifying skills 112 for people 108. For example, skill identifier 110 enables identifying skills 112 with a level of certainty that skills 112 meet policy 134. For example, skills 112 may be identified as being valid, as opposed to someone saying a person has a skill without a way to see if the person making the endorsement of the skill is in a position to make the evaluation of the presence of the skill or the level of proficiency for a skill.

Thus, skill identifier 110 transforms computer system 114 into a special purpose computer system as compared to currently available general computer systems that do not have skill identifier 110. Currently used general computer systems do not reduce the time or effort needed to identify skills 112. Further, currently used general computer systems do not provide for identifying skill 130 as being valid when evidence 132 meets policy 134.

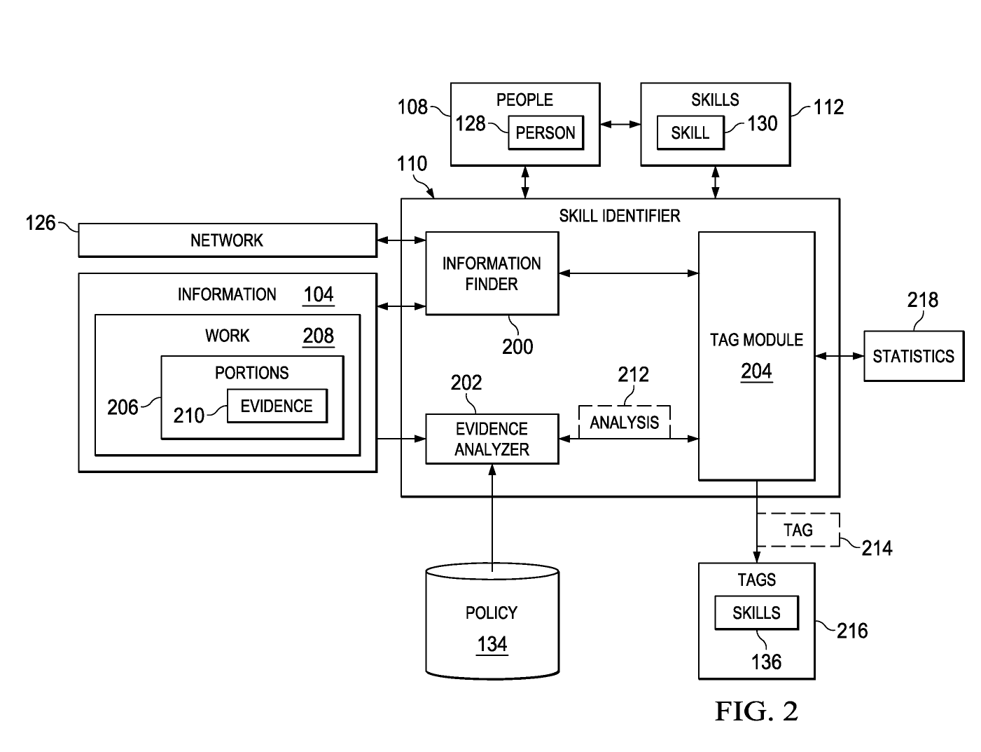

With reference next to FIG. 2, an illustration of a block diagram of data flow for identifying skills in an organization is depicted in accordance with an illustrative embodiment. In this figure, an example of data flow for identifying skills 112 for people 108 that meet policy 134 through skill identifier 110 is shown. In the illustrative examples, the same reference numeral may be used in more than one figure. This reuse of a reference numeral in different figures represents the same element in the different figures.

As depicted, skill identifier 110 has a number of different components. As used herein, a “number of items” means one or more items. For example, “a number of different components” means one or more components.

Skill identifier 110 includes information finder 200, evidence analyzer 202, and tag module 204.

Information finder 200 in skill identifier 110 searches network 126 for information 104 about people 108. In this illustrative example, information finder 200 includes the functionality of at least one of a web crawler, an email analyzer, or other suitable types of tools to search for information 104 about people 108 in network 126.

As depicted, information finder 200 searches for portions 206 of work 208 produced by people 108. Work 208, in this example, is selected from at least one of an endorsement, an evaluation, an email message, a published article, a memorandum, a patent, a prototype, research information, a product, program code, presentation materials, computer aided designs, physical models, or other suitable types of work.

In this illustrative example, portions 206 are subdivisions or pieces of work 208. For example, a portion in portions 206 is selected from at least one of paragraphs, a block of program code, a section of computer aided design, a chart in a presentation, an article, a message, or other suitable types of portions 206 of work 208.

The searching may be performed by matching words in work 208 to skills 112. In this illustrative example, evidence 210 is a portion in portions 206 of work 208. As depicted, evidence 210 in portions 206 is an example of evidence 132 of skill 130 for person 128 in FIG. 1.

For example, when skill 130 is internationalization programming, work 208 may be program code written by person 128. In this example, information finder 200 searches for portions of the program code that include words matching a group of words used by internationalization programmers.

Evidence analyzer 202 applies a group of rules in policy 134 to evidence 210. Evidence analyzer 202 forms analysis 212 based on the results of applying the group of rules to evidence 210.

For example, one rule in policy 134 may verify authorship for evidence. In this example, evidence analyzer 202 determines whether person 128 is the author of evidence 210. The determination may be made by determining whether the identification of information for authorship of evidence 210 matches the identification information for person 128. This identification information is at least one of a name, a phone number, or any other suitable alpha numeric identification for people 108.

Another rule in policy 134 may be to verify that evidence 210 shows a level of skill exceeding a minimum threshold for skill 130. In this example, evidence analyzer 202 processes evidence 210 to determine the level of skill for skill 130 shown in evidence 210.

Still another rule in policy 134 may be to verify that the endorser of any endorsement used as evidence 210 is an approved endorser. An endorser is an approved endorser when the endorser has sufficient proficiency for endorsing skills 112 for people 108 of organization 106. When the endorser is approved, the endorsements made by the endorser can be relied upon. However, when applied to policy 134, the endorsement may not make skill 130 a valid skill for person 128. For example the endorser may state that person 128 has a level of proficiency in the skill. The level of proficiency in the endorsement can be relied upon as being correct. However, the level of proficiency may not be sufficient to make skill 130 valid for person 128 when applied to policy 134.

In this example, when evidence 210 is an endorsement, evidence analyzer 202 may compare the endorser of the endorsement to approved endorsers. For example, an approved endorser with a high level of proficiency for making endorsements may be specified in organization information 107. Using only endorsements provided by approved endorsers ensures that the endorsements are reliable for use as evidence 210.

For example, organization 106 may have a rule in policy 134 that only endorsers with a high level of proficiency for making endorsements may endorse skills 112 for people 108. In this example, forming a team of people 108 based on these skills for people that meet policy 134 has a higher likelihood of success than when endorsers having a low level of proficiency are allowed to make endorsements.

Evidence analyzer 202 sends analysis 212 to tag module 204 when evidence 210 is sufficient to meet policy 134. In this case, skill 130 for person 128 is valid and can be added to the group of skills 136 for person 128.

As depicted, tag module 204 creates tag 214 when tag module 204 receives analysis 212. In this illustrative example, tag 214 includes information specifying that person 128 has skill 130. The information in tag 214 also includes at least one of a pointer to evidence 210, analysis 212 of evidence 210, or other suitable types of information for specifying that person 128 has skill 130.

In this illustrative example, tag module 204 adds tag 214 to tags 216. Adding tag 214 to tags 216 adds skill 130 to the group of skills 136 for person 128. Tags 216 are data structures and include information about skills 136 for people 108. Tags 216 may be stored in at least one of database 138 or other suitable storage.

As depicted, tag module 204 calculates statistics 218 about skills 112 of people 108 in organization 106. Statistics 218 are the results of an analysis of skills 112. In this illustrative example, the analysis is a mathematical analysis that may identify information about skills 112. The information may include, for example, averages, normal distributions, probabilities, and other information.

For example, tag module 204 calculates top skills in statistics 218. These top skills are calculated by adding up numbers of people 108 that have each skill in skills 112 for a number of groups of people 108. A group of people 108 may be selected based on a number of characteristics of people 108. The characteristics may be selected from at least one of a position, a department, a building location, a team, or other characteristic of people 108 in organization 106.

In this illustrative example, tag module 204 calculates top tags in statistics 218. These top tags are calculated by adding up numbers of people 108 that have a tag in tags 216 for each skill in skills 112 for the number of groups of people 108.

Tag module 204 calculates top trending skills in statistics 218. These top trending skills are calculated by adding up numbers of people 108 that have obtained each skill in skills 112 over a selected time period for the number of groups of people 108. Tag module 204 calculates top trending tags in statistics 218. These top trending tags are calculated by adding up numbers of people 108 that have obtained a tag in tags 216 for each skill in skills 112 over a selected time period for the number groups. The selected time period is at least one of 30 days, 1 month, 1 day, 1 week, 3 months, 1 year, or some other suitable time period for identifying trends.

In this illustrative example, skills 136 may be relied on for making decisions on what operations to perform for an organization. Skills 136 are ones that have met policy 134.

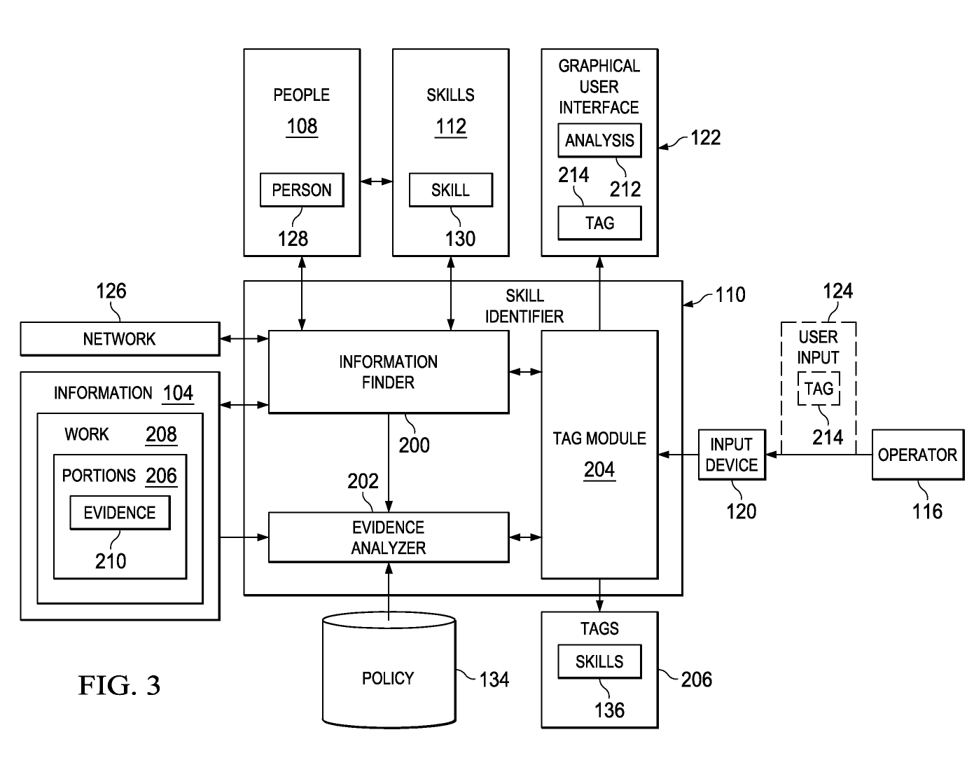

With reference now to FIG. 3, an illustration of a block diagram of data flow for identifying skills in an organization is depicted in accordance with an illustrative embodiment. In this figure, an example of data flow in which user input 124 is received from operator 116 is shown. In this illustrative example, the data flow identifies skills 136 for people 108 that meet policy 134 through skill identifier 110.

In this illustrative example, tag module 204 displays tag 214 in graphical user interface 122. Tag module 204 may also display analysis 212 of evidence 210 of skill 130 for person 128 in graphical user interface 122. In the illustrative example, evidence 210 of skill 130 for person 128 is an endorsement of skill 130 for person 128 made by an endorser. In this example, the endorser is not an approved endorser. As depicted, user input is required to make the endorser an approved endorser before this endorsement is sufficient to meet policy 134.

As depicted, tag module 204 receives user input 124 regarding the endorsement made by the endorser that is not an approved endorser. In this illustrative example, user input 124 is selected from at least one of user input identifying the endorser of the endorsement of skill 130 for person 128 as an approved endorser, or user input identifying the endorser as not an approved endorser.

Tag module 204 may wait for user input 124 before adding tag 214 to tags 216. For example, when tag module 204 receives user input 124 that identifies the endorser of the endorsement of skill 130 for person 128 as not an approved endorser, tag module 204 does not add tag 214 to tags 216.

Tag module 204 may add tag 214 to tags 216 before receiving user input 124. Tag module 204 may remove tag 214 from tags 216 when user input 124 that identifies the endorser of the endorsement of skill 130 for person 128 as not an approved endorser is received.

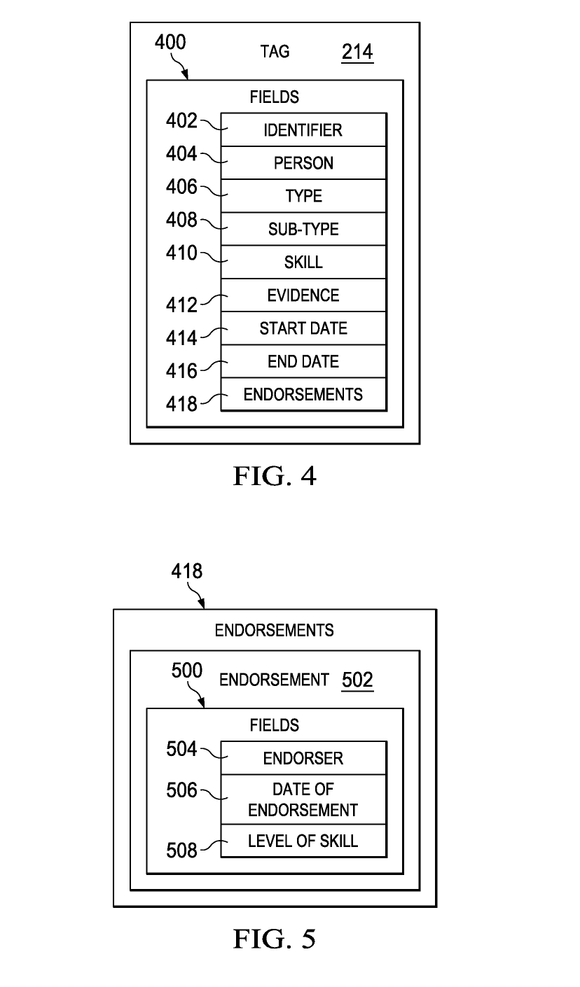

Turning to FIG. 4, an illustration of a block diagram of a tag is depicted in accordance with an illustrative embodiment. In this illustration, an illustration of fields 400 that may be in tag 214 is shown.

As depicted, fields 400 in tag 214 include identifier 402, person 404, type 406, sub-type 408, skill 410, evidence 412, start date 414, end date 416, and endorsements 418. Identifier 402 is a unique identifier for the tag. This unique identifier is selected from at least one of a number, an alpha-numeric string, or any other suitable type of identifier for the tag.

Person 404 is the person identified by the tag as having skill 410. For example, person 404 may be selected from people 108.

Type 406 is the name of a group of tags 216. Type 406 is selected from at least one of social, professional, or some other suitable name for a group of tags. Sub-type 408 is the name of a group of tags within type 406. When type 406 for the tag is social, sub-type 408 is selected from at least one of hobbies or interests. When type 406 for the tag is professional, sub-type 408 is selected from at least one of skills, education, licensing, certification, language, or other suitable sub-types for information about professionals.

Skill 410 in tag 214 is where the skill represented by the tag for the person is located. Evidence 412 is where evidence of skill 410 is located in tag 214.

In this illustrative example, start date 414 in tag 214 is a date that specifies when the skill represented by the tag is valid for the person. End date 416 in tag 214 is a date that specifies when the skill represented by the tag is no longer valid for the person.

For example, when start date 414 is in the past and end date 416 is in the future, these dates indicate that the skill represented by the tag is currently valid. As another example, when these dates are both in the past, these dates indicate that the skill represented by the tag is no longer current or valid for the person.

These dates may be based on a rule in policy 134 for the age of the evidence of the skill. For example, a tag module may generate these dates from information 104. When these dates are in the past, the tag module may remove the tag from tags 216.

As depicted, endorsements 418 are the endorsements for skill 410. For example, endorsements 418 may include zero, one, or any other number of endorsements.

Turning next to FIG. 5, an illustration of a block diagram of an endorsement of skills for a person is depicted in accordance with an illustrative embodiment. In this illustration, an example of fields 500 for endorsements in endorsements 418 in FIG. 4 is shown. Endorsement 502 is an example of an endorsement in endorsements 418.

As depicted, fields 500 in endorsement 502 include endorser 504, date of endorsement 506, and level of skill 508. Endorser 504 is a person who made the endorsement. Date of endorsement 506 is the date when the endorsement was made.

Level of skill 508 in endorsement 502 specifies a level of the skill that the endorser is endorsing. Level of skill 508 is at least one of a value in a range of values, a percentage, or text describing the endorsement.

The illustration of information environment 100 and the different components in FIGS. 1-5 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, information 104 may include information for other people or items in addition to information about people 108. As another example, at least one of type 406, sub-type 408, start date 414, or end date 416 may be omitted from fields 400 in FIG. 4.

As a further example, counters may be included in fields 400 of tag 214 for at least one of the number of times tag 214 is displayed on a graphical user interface in information environment 100, or the number of times tag 214 is selected in a graphical user interface in information environment 100. In this example, selecting tag 214 is at least one of hovering a pointer over tag 214, clicking on tag 214, moving keyboard focus to tag 214, or some other suitable type of user input for selecting tag 214 in information environment 100.

As another example, counters may also be included in fields 500 of endorsement 502 for at least one of the number of times endorsement 502 is displayed on a graphical user interface in information environment 100, or the number of times endorsement 502 is selected in a graphical user interface in information environment 100. In this example, selecting endorsement 502 is at least one of hovering a pointer over endorsement 502, clicking on endorsement 502, moving keyboard focus to endorsement 502, or some other suitable type of user input for selecting endorsement 502 in information environment 100.

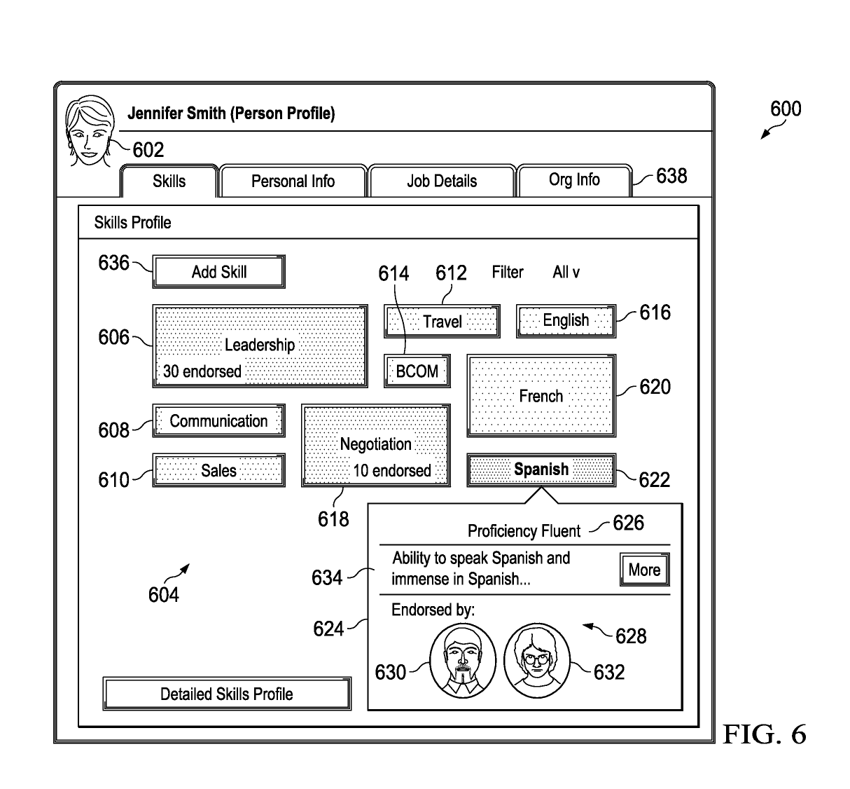

FIGS. 6-9 are illustrative examples of a graphical user interface that may be used to access endorsements of skills. With reference first to FIG. 6, an illustration of a graphical user interface for viewing endorsements of skills for a person is depicted in accordance with an illustrative embodiment. As depicted, graphical user interface 600 is an example of one implementation for graphical user interface 122 shown in block form in FIG. 1.

In this illustrative example, graphical user interface 600 displays a number of different graphical elements. As depicted, graphical user interface 600 includes person 602 and skills 604 for person 602. Person 602 is an example of person 128 shown in block form in FIG. 1.

As depicted, graphical user interface 600 displays an image and a name for person 602. For example, graphical user interface 600 may retrieve the image and the name for person 602 from organization information 107 shown in block form in FIG. 1.

Skills 604 are an example of the group of skills 112 for person 128 shown in block form in FIG. 1. As depicted, skills 604 include leadership 606, communication 608, sales 610, travel 612, business communications (BCOM) 614, English 616, Negotiation 618, French 620, and Spanish 622.

In this illustrative example, the skills in skills 604 may be selected. Graphical user interface 600 displays information window 624 for a skill when the skill is selected. In this illustration, Spanish 622 has been selected.

Information window 624 shows level of skill 626 that person 602 has for Spanish 622. In this illustrative example, level of skill 626 is endorsed by endorsers 628. Endorsers 628 include endorser 630 and endorser 632. Endorser 630 and endorser 632 are examples of people in endorser 504 shown in block form in FIG. 5.

As depicted, information window 624 also shows description of skill 634. Description of skill 634 is text describing what level of skill 626 person 602 has for skill 626.

Add skill button 636 in graphical user interface 600 is used to add skills to skills 604. For example, graphical user interface 600 may display additional graphical user elements when add skill button 636 is selected.

Organization information tab 638 in graphical user interface 600 is used to show statistics for organization 106. For example, these statistics may be about skills 112 for people 108 of organization 106.

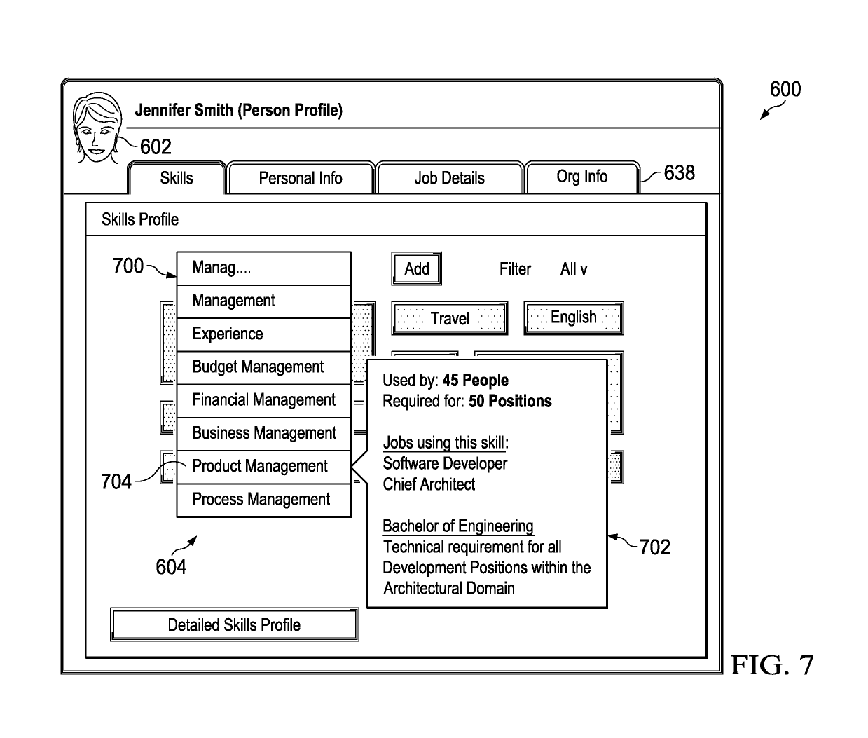

With reference next to FIG. 7, an illustration of a graphical user interface for adding a skill to a group of skills for a person is depicted in accordance with an illustrative embodiment. In this illustration, add skill button 636 has been selected.

As depicted, graphical user interface 600 displays skill selector 700. Skill selector 700 is a user input control for selecting a skill. Skill selector 700 shows a list of skills. Skill selector 700 receives user input to at least one of highlight or select a skill in the list of skills.

In this illustrative example, graphical user interface 600 shows information window 702 when a skill is highlighted in the list of skills in skill selector 700. In this illustrative example, a skill that is highlighted is highlighted skill 704. Information window 702 shows information about highlighted skill 704. In this illustration, product management has been highlighted as highlighted skill 704 in the list of skills in skill selector 700.

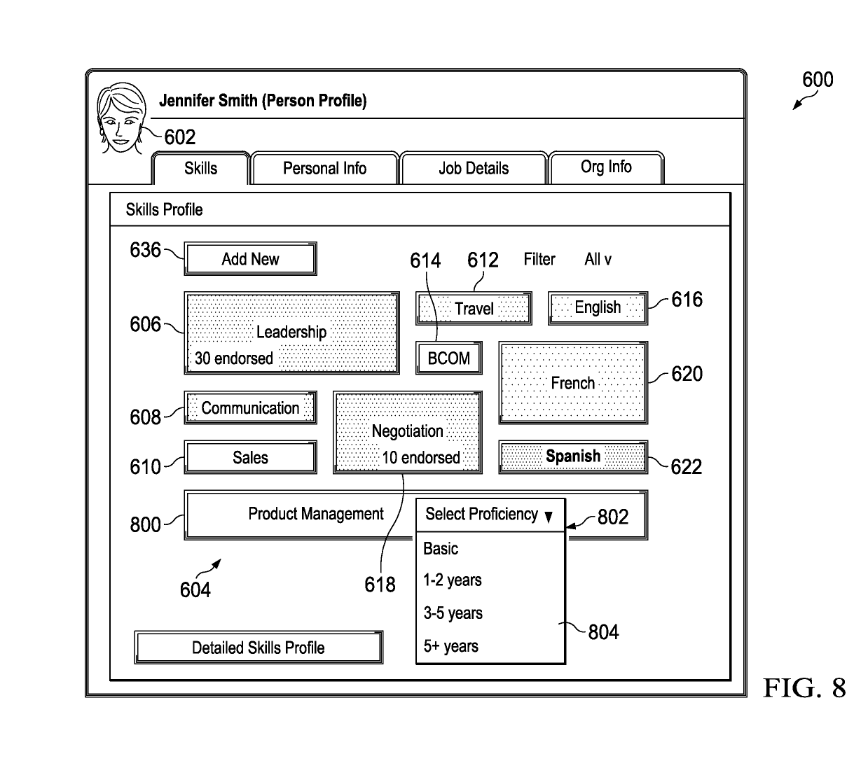

With reference now to FIG. 8, an illustration of a graphical user interface for adding an endorsement to a skill for a person is depicted in accordance with an illustrative embodiment. In this illustration, product management 800 has been added to skills 604 for person 602.

As depicted, graphical user interface 600 displays endorsement control 802 for product management 800. For example, graphical user interface 600 may display endorsement control 802 when skill identifier 110 has not found evidence 210 of product management 800 for person 602.

Endorsement control 802 is a user input control for selecting a level of skill for an endorsement. Endorsement control 802 shows levels of skill 804 for product management 800. Levels of skill 804 are examples of level of skill 508 shown in block form in FIG. 5. For example, selecting a level of skill in levels of skill 804 may add an endorsement for product management 800 for person 602. This endorsement may then be used as evidence 210 of product management 800 for person 602.

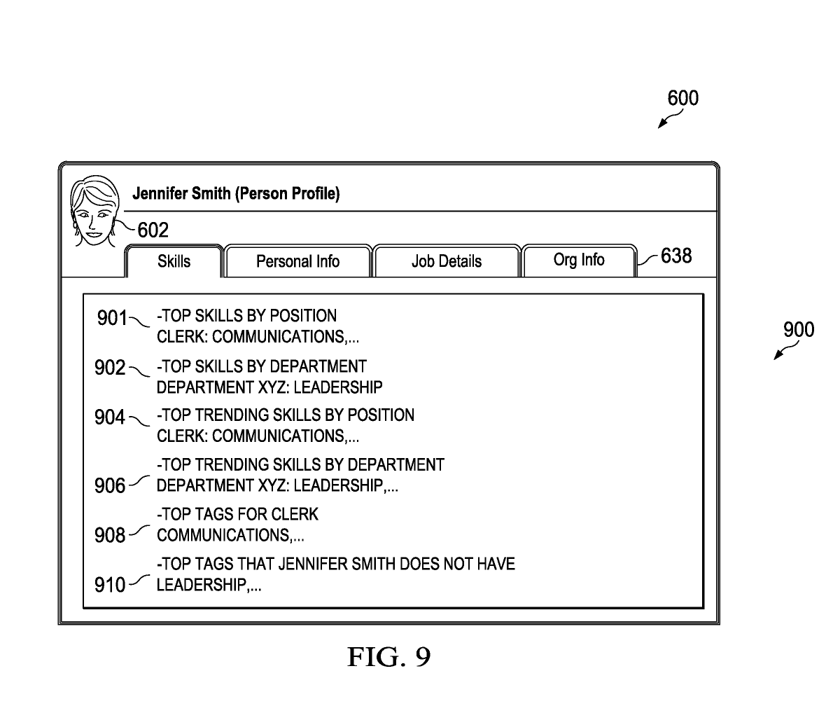

Turning to FIG. 9, an illustration of a graphical user interface for displaying statistics about skills for people of an organization is depicted in accordance with an illustrative embodiment. In this illustration, organization information tab 638 has been selected.

As depicted, graphical user interface 600 displays statistics 900. Statistics 900 show examples of statistics 218 shown in block form in FIG. 2.

In this illustrative example, statistics 900 include top skills by position 901, top skills by department 902, top trending skills by position 904, top trending skills by department 906, top tags 908 for the position held by person 602, and top tags 910 that person 602 does not have. Top skills by position 901 shows the top of a number of skills 112 that people 108 in organization 106 have for a position in the organization. Top skills by department 902 shows the top of a number of skills 112 that people 108 in organization 106 have for a department in the organization.

Top trending skills by position 904 shows the top of a number of skills 112 trending in the organization for a position. Top trending skills by department 906 shows the top of a number of skills 112 trending in the organization for a department. Top tags 908 for the position held by person 602 shows a top of a number of tags 216 that people 108 have in a position that person 602 has in organization 106 shown in block form in FIG. 1. Top tags 910 that person 602 does not have shows a top of a number of tags 216 that people 108 in the position of person 602 have that person 602 does not have.

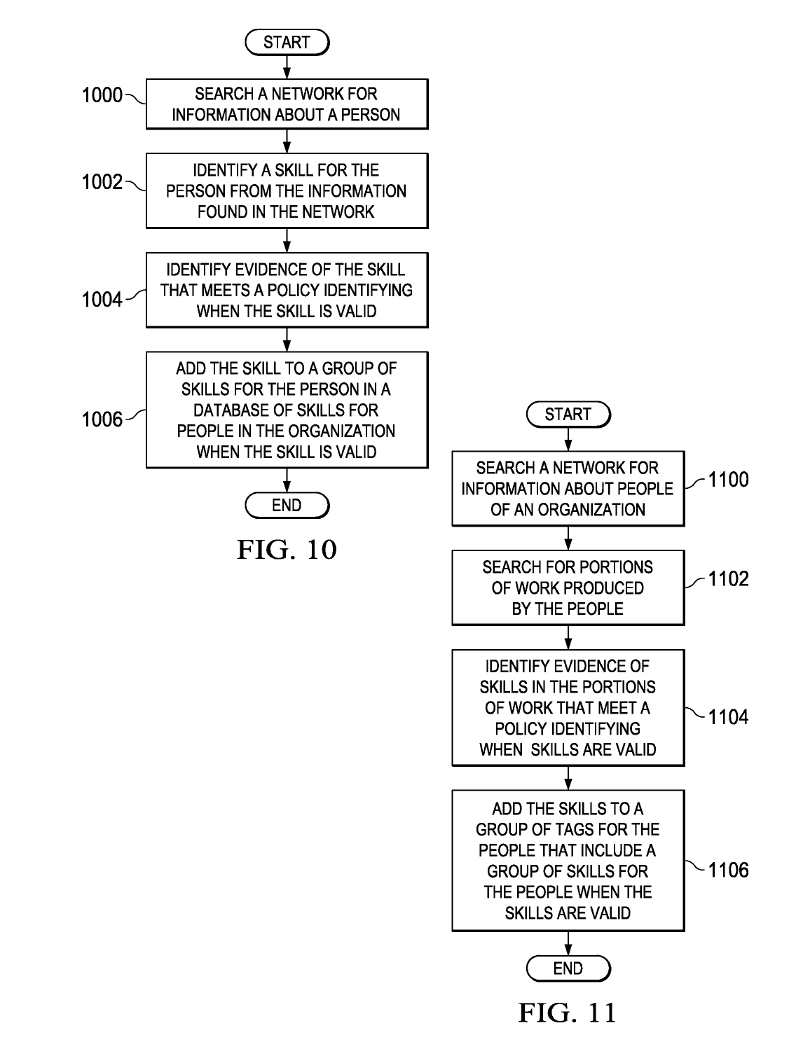

Turning next to FIG. 10, an illustration of a flowchart of a process for identifying skills is depicted in accordance with an illustrative embodiment. The process illustrated in FIG. 10 may be implemented in information environment 100 shown in block form in FIG. 1. This process may be used to enable operations for organization 106. In particular, the process may be implemented in skill identifier 110 in computer system 114.

The process begins by searching a network for information about a person (step 1000). The process then identifies a skill for the person from the information found in the network (step 1002). The process identifies evidence of the skill that meets a policy identifying when the skill is valid (step 1004). The process adds the skill to a group of skills for the person in a database of skills for people in the organization when the skill is valid (step 1006) with the process terminating thereafter. In this manner, performing an action in the organization based on the skills for the people in the organization is enabled.

Turning now to FIG. 11, an illustration of a flowchart of a process for identifying skills is depicted in accordance with an illustrative embodiment. The process illustrated in FIG. 11 may be implemented in information environment 100 shown in block form in FIG. 1. This process may be used to enable operations for organization 106. In particular, the process may be implemented in skill identifier 110 in computer system 114.

The process begins by searching a network for information about people of an organization (step 1100). The process then searches for portions of work produced by the people (step 1102).

The process identifies evidence of skills in the portions of work that meet a policy identifying when skills are valid (step 1104). The process adds the skills to a group of tags for the people that include a group of skills for the people when the skills are valid (step 1106) with the process terminating thereafter. In this manner, performing an action in the organization based on the skills for the people in the organization is enabled.

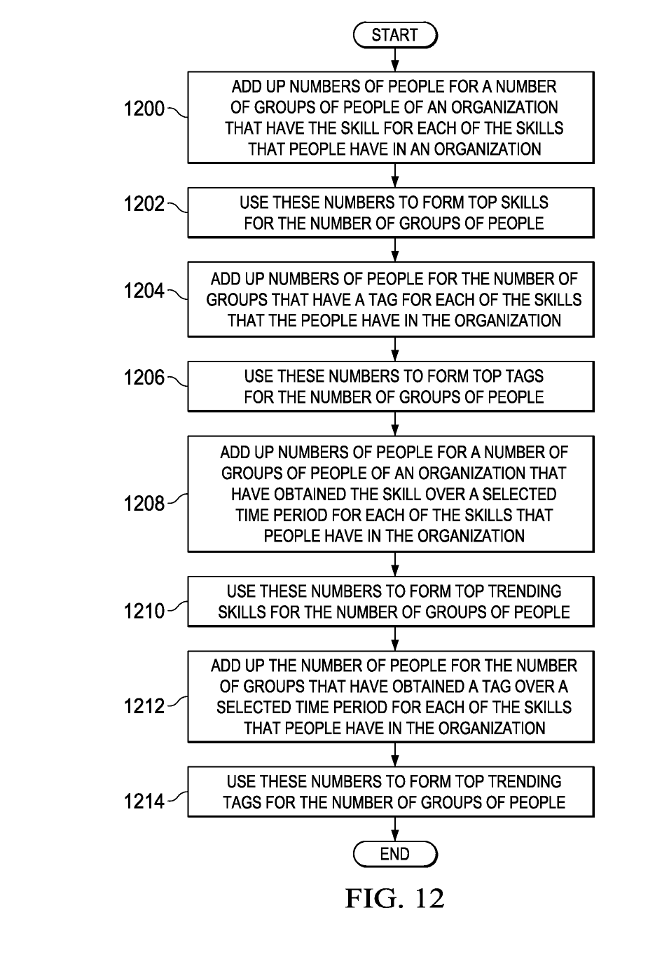

Turning now to FIG. 12, an illustration of a flowchart of a process for identifying statistics about skills is depicted in accordance with an illustrative embodiment. The process illustrated in FIG. 12 may be implemented in information environment 100 shown in block form in FIG. 1. This process may be used to enable operations for organization 106. In particular, the process may be implemented in skill identifier 110 in computer system 114.

The process begins by adding up numbers of people for a number of groups of people of an organization that have the skill for each of the skills that people have in an organization (step 1200). The process uses these numbers to form top skills for the number of groups of people (step 1202).

The process next adds up numbers of people for the number of groups that have a tag for each of the skills that the people have in the organization (step 1204). The process uses these numbers to form top tags for the number of groups of people (step 1206).

The process adds up numbers of people for a number of groups of people of an organization that have obtained the skill over a selected time period for each of the skills that people have in the organization (step 1208). The process uses these numbers to form top trending skills for the number of groups of people (step 1210).

The process next adds up the number of people for the number of groups that have obtained a tag over a selected time period for each of the skills that people have in the organization (step 1212). The process uses these numbers to form top trending tags for the number of groups of people (step 1214) with the process terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

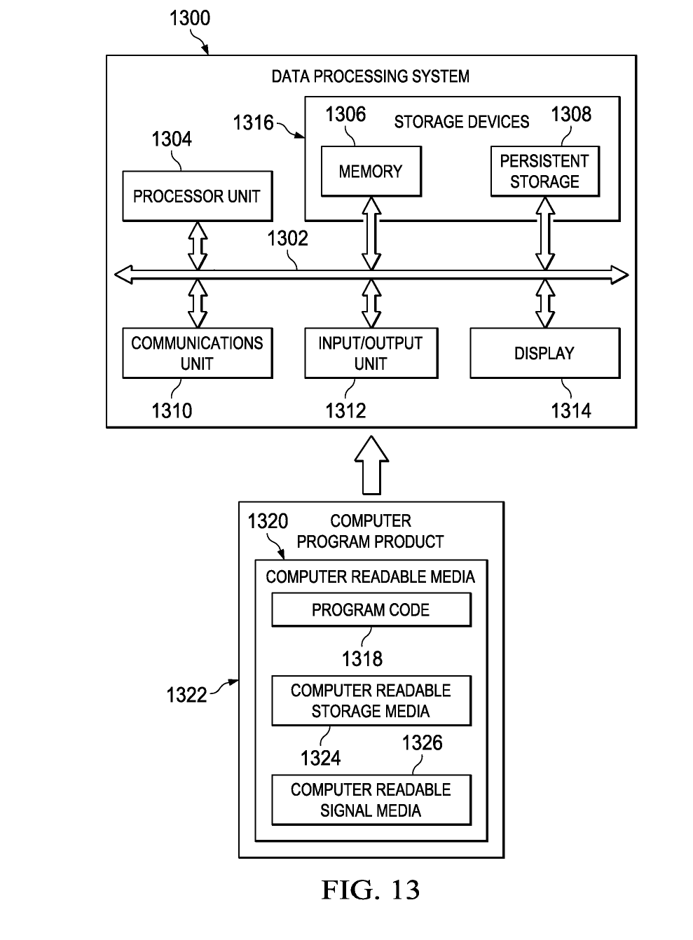

Turning now to FIG. 13, an illustration of a block diagram of a data processing system is depicted in accordance with an illustrative embodiment. Data processing system 1300 may be used to implement computer system 114 in FIG. 1. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 may take the form of a bus system.

Processor unit 1304 serves to execute instructions for software that may be loaded into memory 1306. Processor unit 1304 may be a number of processors, a multi-processor core, or some other type of processor, depending on the particular implementation.

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a flash memory, a rewritable optical disk, a rewritable magnetic tape, or some combination of the above. The media used by persistent storage 1308 also may be removable. For example, a removable hard drive may be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least of a keyboard, a mouse, or some other suitable input device. Further, input/output unit 1312 may send output to a printer. Display 1314 provides a mechanism to display information to a user.

Instructions for at least one of the operating system, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer usable program code, or computer readable program code that may be read and executed by a processor in processor unit 1304. The program code in the different embodiments may be embodied on different physical or computer readable storage media, such as memory 1306 or persistent storage 1308.

Program code 1318 is located in a functional form on computer readable media 1320 that is selectively removable and may be loaded onto or transferred to data processing system 1300 for execution by processor unit 1304. Program code 1318 and computer readable media 1320 form computer program product 1322 in these illustrative examples. In one example, computer readable media 1320 may be computer readable storage media 1324 or computer readable signal media 1326.

In these illustrative examples, computer readable storage media 1324 is a physical or tangible storage device used to store program code 1318 rather than a medium that propagates or transmits program code 1318. Alternatively, program code 1318 may be transferred to data processing system 1300 using computer readable signal media 1326. Computer readable signal media 1326 may be, for example, a propagated data signal containing program code 1318. For example, computer readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1300. Other components shown in FIG. 13 can be varied from the illustrative examples shown. The different embodiments may be implemented using any hardware device or system capable of running program code 1318.

Thus, the illustrative examples in the different figures provide one or more technical solutions to overcome a technical problem of having amounts of information that make identifying characteristics of people more cumbersome and time-consuming than desired. For example, skill identifier 110 identifies skills from searching information in a network. The skill may be added to a group of skills when the skills are considered to be valid. The validation of the skill in these illustrative examples may be performed by comparing the evidence of the skill to a policy. If the evidence meets a policy, then the skills are considered valid and are added to a group of skills for one or more people. In this manner, in performing operations with respect to an organization, more certainty is present in making decisions to perform operations that rely on the presence of skills. In this manner, the use of skill identifier 110 has a technical effect of reducing time, effort, or both in identifying skills for people as well as in performing operations for an organization.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for identifying skills in an organization, the method comprising:
searching, by a computer system, a network for information about a person;
identifying, by the computer system, a skill for the person from the information found in the network;
identifying, by the computer system, evidence of the skill that meets a policy that identifies when the skill is valid; and
adding, by the computer system, the skill to a group of skills for the person in a database of skills for people in the organization when the skill is valid, enabling performing an operation for the organization based on the skills for the people in the organization for which the evidence is present that meets the policy.

2. The method of claim 1 further comprising:
performing the operation for the organization using the skills for the people in the organization.

3. The method of claim 1 further comprising:
identifying, by the computer system, a top of a number of skills that the people in the organization have for one of a position in the organization, a department in the organization, a building location of the organization, or a team in the organization.

4. The method of claim 1 further comprising:
identifying, by the computer system, a top of a number of skills trending in the organization for one of a position, a department, a building location, or a team.

5. The method of claim 1 further comprising:
identifying, by the computer system, a top of a number of tags that the people in a position of the person have in the organization.

6. The method of claim 1 further comprising:
identifying, by the computer system, a top of a number of tags that the people in a position of the person have that the person does not have.

7. The method of claim 1, wherein work by the person is the evidence of the skill and identifying the evidence of the skill that meets the policy that identifies when the skill is valid comprises:
analyzing, by the computer system, the work by the person to form an analysis; and
determining, by the computer system, whether the work by the person meets the policy based on the analysis.

8. The method of claim 7 further comprising:
storing, by the computer system, a pointer to the work by the person as the evidence of the skill for the person in the database of skills.

9. The method of claim 7, wherein the analyzing step comprises:
searching, by the computer system, for the work by the person; and
analyzing, by the computer system, the work by the person to form the analysis.

10. The method of claim 1, wherein the database of skills is a database of tags that include the skills, wherein the group of skills are stored in a group of tags in the database of tags, and wherein a tag in the group of tags includes at least one of the skill, a start date for when the skill is valid for the person, and an end date for when the skill is no longer valid for the person.

11. The method of claim 1, wherein the information is selected from at least one of an email message, an evaluation, a memorandum, research information, a patent, and a published article.

12. A computer system comprising:
a display system; and
a skill identifier in communication with the display system, wherein the skill identifier searches a network for information about a person; identifies a skill for the person from the information found in the network;
identifies evidence of the skill that meets a policy identifying when the skill is a valid; and adds the skill to a group of skills for the person in a database of skills for people in an organization when the skill is valid, enabling performing an operation for the organization based on skills for the people in the organization for which the evidence is present that meets the policy.

13. The computer system of claim 12, wherein the skill identifier performs the operation for the organization using the skills for the people.

14. The computer system of claim 12, wherein the skill identifier identifies a top of a number of skills that the people in the organization have for one of a position in the organization, a department in the organization, a building location of the organization, or a team in the organization.

15. The computer system of claim 12, wherein the skill identifier identifies a top of a number of skills trending in the organization for one of a position, a department, a building location, or a team.

16. The computer system of claim 12, wherein the skill identifier identifies a top of a number of tags that the people in a position of the person have in the organization.

17. The computer system of claim 12, wherein the skill identifier identifies a top of a number of tags that the people in a position of the person have that the person does not have.

18. The computer system of claim 12, wherein work by the person is the evidence of the skill and in identifying the evidence of the skill that meets the policy that identifies when the skill is valid, the skill identifier determines whether the work by the person meets the policy based on an analysis.

19. The computer system of claim 18, wherein the skill identifier stores a pointer to the work by the person as the evidence of the skill for the person in the database of skills.

20. The computer system of claim 18, wherein in analyzing work by the person to form an analysis, analyzing the work by the person to form the analysis searches for the work by the person and analyzes the work by person to form the analysis.

21. The computer system of claim 12, wherein the database of skills is a database of tags that include the skills, wherein the group of skills are stored in a group of tags in the database of tags, and wherein a tag in the group of tags includes at least one of the skill, a start date for when the skill is valid for the person, and an end date for when the skill is no longer valid for the person.

22. A computer program product for identifying skills in an organization, the computer program product comprising:
a computer readable storage media;
first program code, stored on the computer readable storage media, for searching a network for information about a person;
second program code, stored on the computer readable storage media, for identifying a skill for the person from the information found in the network;
third program code, stored on the computer readable storage media, for identifying evidence of the skill that meets a policy that identifies when the skill is valid; and
fourth program code, stored on the computer readable storage media, for adding the skill to a group of skills for the person in a database of skills for people in the organization when the skill is valid, enabling performing an operation for the organization based on the skills for the people in the organization for which the evidence is present that meets the policy.

23. The computer program product of claim 22 further comprising:
fifth program code, stored on the computer readable storage media, for identifying a top of a number of skills that the people in the organization have for one of a position in the organization, a department in the organization, a building location of the organization, or a team in the organization.

24. The computer program product of claim 22 further comprising:
fifth program code, stored on the computer readable storage media, for identifying a top of a number of skills trending in the organization for one of a position, a department, a building location, or a team.

25. The computer program product of claim 22 further comprising:
fifth program code, stored on the computer readable storage media, for identifying a top of a number of tags that the people in a position of the person have in the organization.

26. The computer program product of claim 22 further comprising:
fifth program code, stored on the computer readable storage media, for identifying a top of number of tags that the people in a position of the person have that the person does not have.

27. The computer program product of claim 22, wherein work by the person is the evidence of the skill and the third program code comprises:
program code, stored on the computer readable storage media, for analyzing the work by the person to form an analysis; and
program code, stored on the computer readable storage media, for determining whether the work by the person meets the policy based on the analysis.

28. The computer program product of claim 27, wherein the third program code further comprises:
program code, stored on the computer readable storage media, for storing a pointer to the work by the person as the evidence of the skill for the person in the database of skills.

29. The computer program product of claim 27, wherein the program code for analyzing the work by the person to form the analysis comprises:
program code, stored on the computer readable storage media, for searching for the work by the person; and
program code, stored on the computer readable storage media, for analyzing the work by the person to form the analysis.

30. The computer program product of claim 22, wherein the database of skills is a database of tags that includes the skills, wherein the group of skills are stored in a group of tags in the database of tags, and wherein a tag in the group of tags includes at least one of the skill, a start date for when the skill is valid for the person, and an end date for when the skill is no longer valid for the person.
